(19) United States
(12) Patent Application Publication
(10) Pub. No.: US 2006/0126977 A1
(43) Pub. Date: Jun. 15, 2006

(54) Fluid Dynamic Pressure Bearing Device, and Spindle Motor and Recording Disk Driving Apparatus

(75) Inventor: Takehito Tamaoka, Kyoto (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: NIDEC CORPORATION, Kyoto (JP)

(21) Appl. No.: 11/164,283

(22) Filed: Nov. 17, 2005

(30) Foreign Application Priority Data
Nov. 17, 2004 (JP) JP-2004-332877
Nov. 16, 2005 (JP) JP-2005-331126

(51) Int. Cl. F16C 32/06

(52) U.S. Cl. 384/100

(57) ABSTRACT

Vertical grooves extending in the axial direction are formed at equal intervals in the circumferential direction in the inner peripheral surface of a housing. By fixing the outer peripheral surface of a sleeve formed by a sintered metal having a cylindrical-shaped outer peripheral surface and the inner peripheral surface of the housing, a communication hole is formed. The communication hole is formed longer than the length from the top face to the under face of the sleeve.

### BACKGROUND OF THE INVENTION

1. Technical Field

The present invention relates to a fluid dynamic pressure bearing device using a lubricating fluid, a spindle motor using the fluid dynamic pressure bearing device, and a recording disk driving apparatus using a fluid dynamic pressure bearing device.

2. Description of the Related Art

In recent years, an important subject of a recording disk driving apparatus used in equipment such as a personal computer is to realize lower price and smaller current.

A sintered metal is applied as a bearing member of a fluid dynamic pressure bearing in a spindle motor (hereinbelow, simply called a motor) mounted on a recording disk driving apparatus for realizing lower price of a recording disk driving apparatus. Moreover, to realize smaller current in the recording disk driving apparatus, the width in the radial direction between the inner peripheral surface and the outer peripheral surface of the bearing member of the sintered metal is set to be small.

In the conventional bearing member to which the sintered metal is applied, a communication hole for circulating a lubricating fluid is provided in the outer peripheral surface of the sintered metal. However, at the time of integrally forming a dynamic pressure groove in the inner peripheral surface of the sintered metal and the insertion hole, the force of forming the dynamic pressure groove escapes to the communication hole, so that the inner peripheral surface in the radial direction in which the communication hole is provided deforms. Further, since the width in the radial direction is reduced, also at the time of forming the communication hole in the outer peripheral surface of the sintered metal, an influence is exerted on the inner peripheral surface. As a result, circularity of the inner peripheral surface of the bearing member deteriorates. Due to deterioration in the circularity of the bearing part, a rotator supported by the bearing part is not supported with high precision and runs out. As a result, it causes vibration and noise in the motor. Moreover, also in a disk driving apparatus, an erroneous operation occurs in recording and reproduction of information to/from a disk.

### BRIEF SUMMARY OF THE INVENTION

According to the present invention, a fluid dynamic pressure bearing device, a spindle motor, and a disk driving apparatus in each of which deterioration in circularity of a inner peripheral surface of a bearing part is prevented can be provided.

A fluid dynamic pressure bearing device of the present invention has: a shaft rotating along a rotation axis; a cylindrical-shaped sleeve formed by a sintered metal rotatably supporting the shaft; a housing fixed to the outer peripheral surface of the sleeve; and a counter plate hermetically closing of the housing. Between a lower face of the sleeve and an upper face of the counter plate, an axial gap is formed.

In the fluid dynamic pressure bearing of the invention, one or more communication holes communicating an upper face and the lower face of the sleeve are formed along an axial direction in the inner peripheral surface of the housing.

The housing and the counter plate may be formed integrally. Further, the housing may be formed by plastic process or resin molding.

Further, the fluid dynamic pressure bearing may be also used for a spindle motor and a recording disk driving apparatus on which the spindle motor is mounted.

The fluid dynamic pressure bearing apparatus of the invention can be formed in a cylindrical shape in which no groove or recess is formed in an outer peripheral surface of the sleeve formed by a sintered metal by providing a communication hole on the housing side. Therefore, at the time of molding the sleeve, deterioration in circularity of the inner peripheral surface due to the influence of the groove or recess in the outer peripheral surface can be prevented. As a result, the spindle motor and the recording disk driving apparatus realizing no run-out of the shaft and low vibration can be provided.

### BRIEF DESCRIPTION OF THE SEVERAL VIEWS OF THE DRAWINGS

FIG. 1 is a schematic cross section taken along the axial direction of a mode of a fluid dynamic pressure bearing device in the present invention.

FIG. 2 is a schematic cross section taken along the axial direction of another mode of the fluid dynamic pressure bearing device in the invention.

FIG. 3 is a schematic cross section taken along the axial direction of a jig for forming a dynamic pressure generating groove in a sleeve in the invention and the sleeve.

FIG. 4 is a schematic cross section taken along the axial direction showing the jig for forming the dynamic pressure generating groove in the sleeve in the invention and a scene of forming the dynamic pressure groove in the sleeve.

FIG. 5 is a cross section taken along line X-X of a housing in FIG. 1 and seen from the direction of the arrow.

FIG. 6 is a cross section taken along line X-X of a housing in FIG. 1 and seen from the direction of the arrow.

FIG. 7 is a cross section taken along line Y-Y of a housing in FIG. 2 and seen from the direction of the arrow.

FIG. 8 is a cross section taken along line Y-Y of the housing and the sleeve in FIG. 2 and seen from the direction of the arrow.

FIG. 9 is a schematic cross section taken in the axial direction of a mode of a spindle motor in the invention.

FIG. 10 is a schematic cross section taken in the axial direction of another mode of the spindle motor in the invention.

FIG. 11 is a schematic cross section showing a mode of a recording disk driving apparatus in the invention.

### DETAILED DESCRIPTION OF THE INVENTION

Fluid Dynamic Pressure Bearing Device

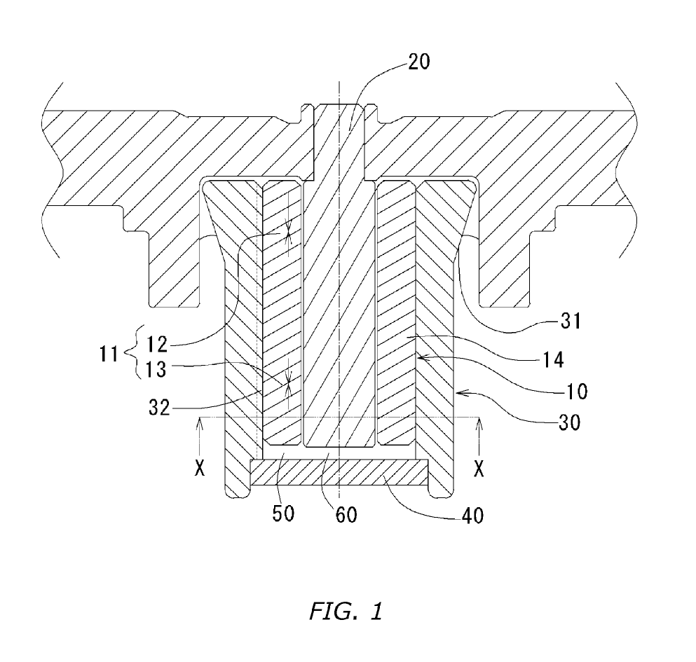

An embodiment of a fluid dynamic pressure bearing device of the invention will be described with reference to FIG. 1. FIG. 1 is a schematic cross section in the axial direction of the fluid dynamic pressure bearing device. An alternate long and short dash line in the diagram indicates a rotation axis. A dotted line indicates a communication hole 32 which will be described later.

A sleeve 10 is a sintered metal and formed in a cylindrical shape having a through hole using a rotation axis as a center. In the inner peripheral surface of the through hole, an upper radial dynamic pressure generating groove 12 and a lower radial dynamic pressure generating groove 13 as dynamic pressure generating grooves 11 spaced in the axial direction are formed. Along the inner peripheral surface of the through hole, a shaft 20 having a circular column shape is inserted. The dynamic pressure generating grooves 11 may be formed on the shaft 20 side. By the dynamic pressure generating grooves 11, a bearing part is formed.

A housing 30 is fixed to the outer peripheral surface of a cylindrical part 14 of the sleeve 10 by, for example, an adhesive. The housing 30 is formed by press working or resin molding. The housing 30 has a cylindrical shape having an inner peripheral surface to which the sleeve 10 is fixed. In an upper part of the outer peripheral surface of the housing 30, a taper part 31 having a tapered shape which extends outward in the radial direction toward the upper side in the axial direction is formed.

A lower part of the inner peripheral surface of the housing 30 extends to the lower side in the axial direction of the sleeve 10. To the inner peripheral surface, a counter plate 40 having a disc shape is fixed by, for example, welding. An axial gap 50 is formed between an upper face of the counter plate 40 and a lower face of the sleeve 10. Alternately, the axial gap 50 may be formed by forming a recess in the upper face of the counter plate 40. In this case, the lower face of the sleeve 10 and the upper face of the counter plate 40 may be in contact with each other. With the configuration, the position in the axial direction of the sleeve 10 can be determined easily. In this case, the axial gap 50 is formed to the inside of the inner peripheral surface of the sleeve 10.

In the inner peripheral surface of the housing 30, the communication hole 32 for providing a gap in cooperation with the outer peripheral surface of the sleeve 10 is formed by providing a recess in the inner peripheral surface. The recess may be a groove. The inner peripheral surface may be formed in a shape which is not completely round and the communication hole 32 may be formed between the inner peripheral surface and the outer peripheral surface of the sleeve 10. At least one communication hole 32 is formed. In the case where a plurality of communication holes 32 are formed, preferably, they are formed at equal intervals in the circumferential direction. The communication hole 32 is formed so as to be longer than the length from the top face to the under face of the outer peripheral surface of the sleeve 10. The communication hole 32 communicates with the axial gap 50.

The fluid bearing device is filled with a lubricating fluid 60. The gap between the outer peripheral surface of the shaft 20 and the inner peripheral surface of the sleeve 10, the axial gap 50, and the communication hole 32 are substantially fully filled.

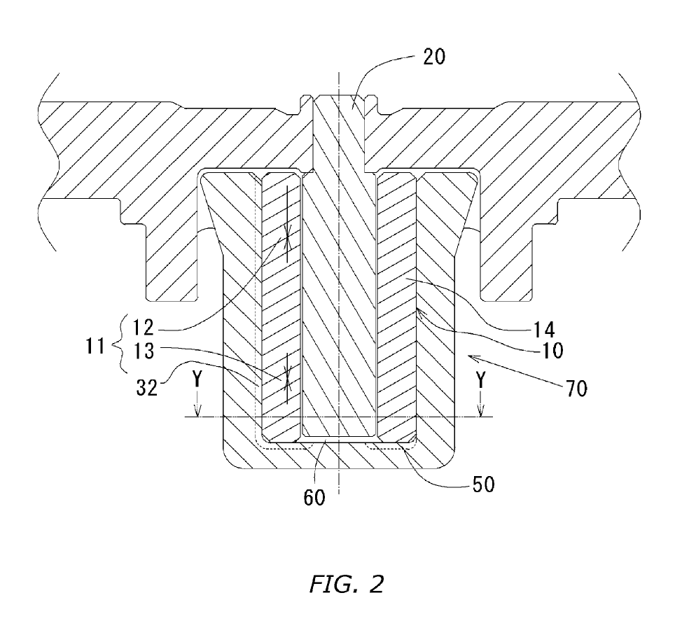

The housing 30 and the counter plate 40 may be replaced with a housing 70 integrally molded as shown in FIG. 2. In this case, reduction in the number of members and reduction in the number of works because of the reduction in the number of members can be realized, so that a low-priced fluid dynamic pressure bearing device can be provided.

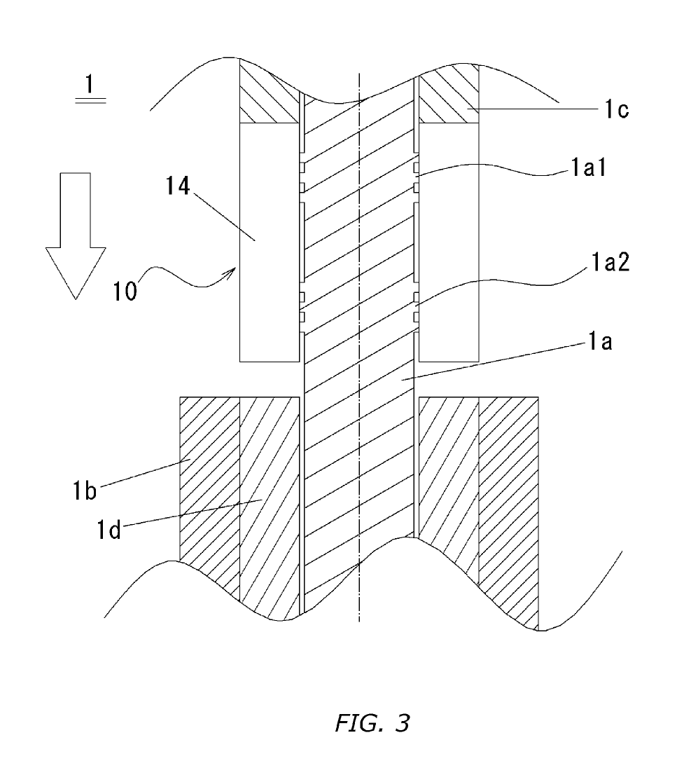

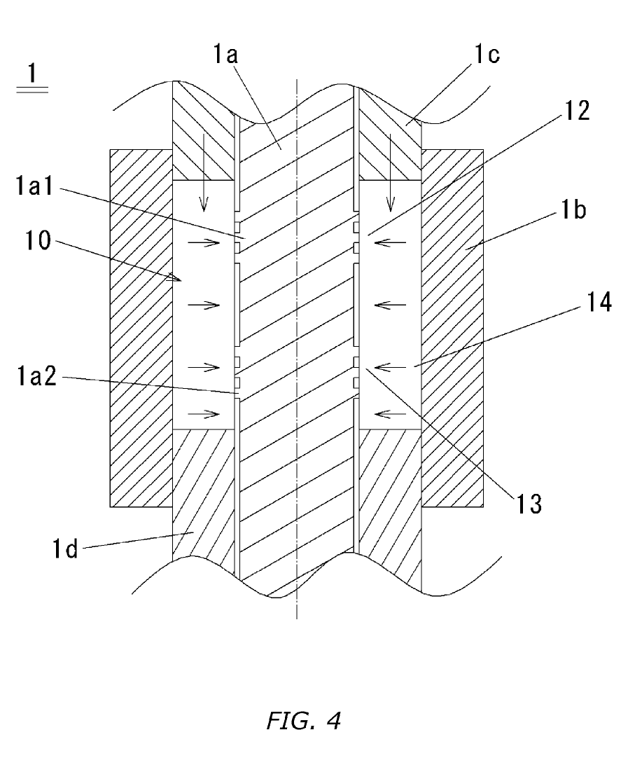

Formation of the sleeve 10 will now be described with reference to FIGS. 3 and 4. FIG. 3 is a schematic diagram before the dynamic pressure generating groove 11 is formed in the inner peripheral surface, and FIG. 4 is a schematic diagram showing a state where the dynamic pressure generating groove 11 is formed in the inner peripheral surface.

Referring to FIG. 3, the jig 1 for forming the dynamic pressure generating groove 11 in the inner peripheral surface of the sleeve 10 is constructed by a dynamic pressure groove forming jig 1a inserted along the inner peripheral surface of the sleeve 10, an external reception jig 1b having a cylindrical-shaped inner peripheral surface which comes into contact with and holds the outer peripheral surface of the sleeve 10, and a top press jig 1c and a bottom reception jig 1d which come into contact with and hold the top face and the under face, respectively, of the sleeve 10. The top face and the under face of the sleeve 10 are held by the top press jig 1c and the bottom reception jig 1d. The sleeve 10 is inserted along the inner peripheral surface of the external reception jig 1b in a state where the dynamic pressure forming jig 1a is inserted along the inner peripheral surface. The outer peripheral surface of the sleeve 10 and that of the outer reception jig 1b come into contact with each other without any gap. In the dynamic pressure groove forming jig 1a, projections for forming the upper-side radial dynamic pressure generating groove 12 and the lower-side radial dynamic pressure generating groove 13 are formed. Consequently, gaps are formed between the outer peripheral surface of the dynamic pressure groove forming jig 1a and the inner peripheral surface of the sleeve 10.

Referring to FIG. 4, in a state where the sleeve 10 is inserted in the external reception jig 1b and the bottom reception jig 1d is fixed, the sleeve 10 is made stay by the top press jig 1c. Therefore, a force applied on the sleeve 10 by the top press jig 1c escapes to the inner peripheral surface having the gaps with the outer peripheral surface of the dynamic pressure groove forming jig 1a. As a result, the entire inner peripheral surface of the sleeve 10 is uniformly deformed toward the outer peripheral surface of the dynamic pressure groove forming jig 1a so as to fill the gaps.

If the communication hole 32 is formed around the outer peripheral surface of the sleeve 10, at the time of forming the dynamic pressure groove generating jig 111 in the inner peripheral surface, the force escapes to the gap formed between the outer peripheral surface of the communication hole 32 and the inner peripheral surface of the external reception jig 1b by the force applied to the top face of the sleeve 10 of the top press jig 1c and the pressure on the outside in the radial direction applied to the inner peripheral surface of the sleeve 10 of the dynamic pressure groove forming jig 1a. Consequently, the force of deforming the inner peripheral surface becomes non-uniform in the entire inner peripheral surface. As a result, it causes deterioration in circularity of the inner peripheral surface of the sleeve 10.

However, since the communication hole 32 is formed on the housing 30 side, the outer peripheral surface of the sleeve 10 used in the present invention can be formed in a cylindrical shape. Consequently, the forces applied to the sleeve 10 of the top press jig 1c and the dynamic pressure groove forming jig 1a escape only to the inner peripheral surface of the sleeve 10. Due to this, only the inner peripheral surface of the sleeve 10 can deform. Therefore, even if the thickness in the radial direction of the cylindrical part of the sleeve 10 is reduced, no influence is exerted on the circularity of the inner peripheral surface. It can prevent run-out of the shaft 20 due to deterioration of the circularity. As a result, a low-vibration fluid dynamic pressure bearing device can be provided.

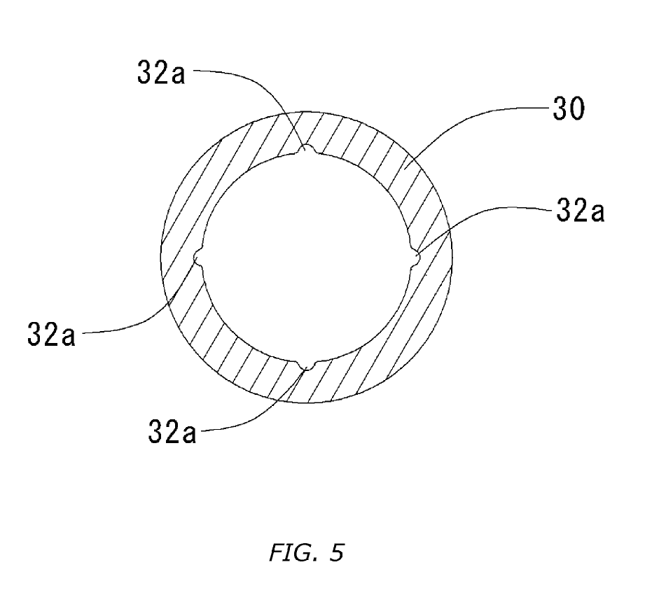

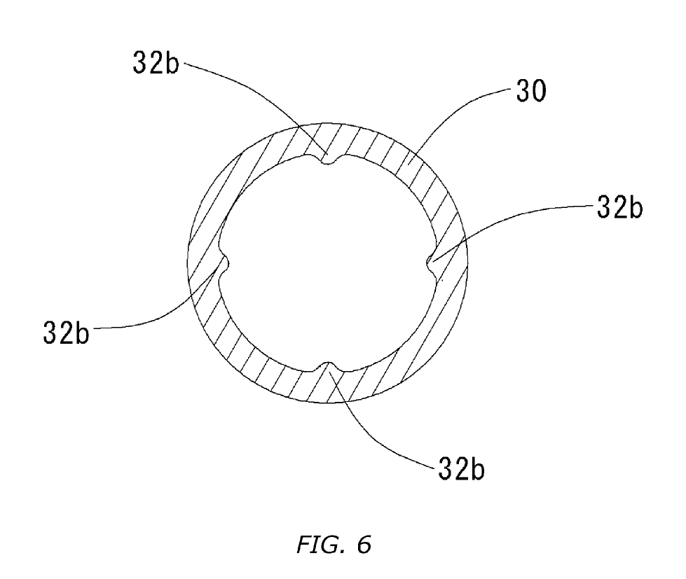

The details of the communication hole 32 will now be described with reference to FIGS. 5 and 6. FIGS. 5 and 6 is a cross section taken along the line X-X of FIG. 1 of the housing 30 and seen from the direction of the arrow.

Referring to FIG. 5, a plurality of vertical grooves 32a are formed in the inner peripheral surface of the housing 30. The vertical grooves 32a are formed at equal intervals in the circumferential direction. The vertical grooves 32a are formed so as to axially extend in the inner peripheral surface of the housing 30 to communicate with the axial gap 50. By the inner peripheral surface of the vertical grooves 32a and the outer peripheral surface of the sleeve 10, the communication holes 32 are formed.

Referring to FIG. 6, parts corresponding to the vertical grooves 32a may be formed as projections 32b in the vertical direction. The projections 32b in the vertical direction come into contact with the outer peripheral surface of the sleeve 10. The communication holes 32 may be formed between the inner peripheral surfaces between the neighboring projections 32b in the vertical direction and the outer peripheral surface of the sleeve 10.

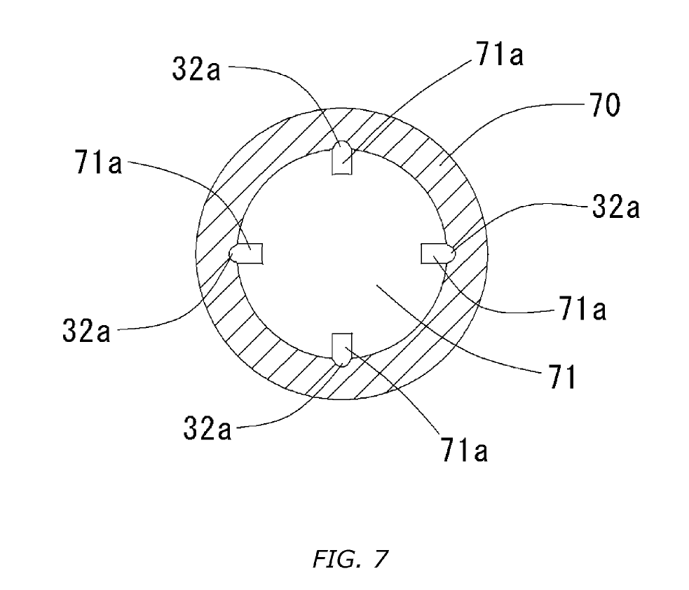

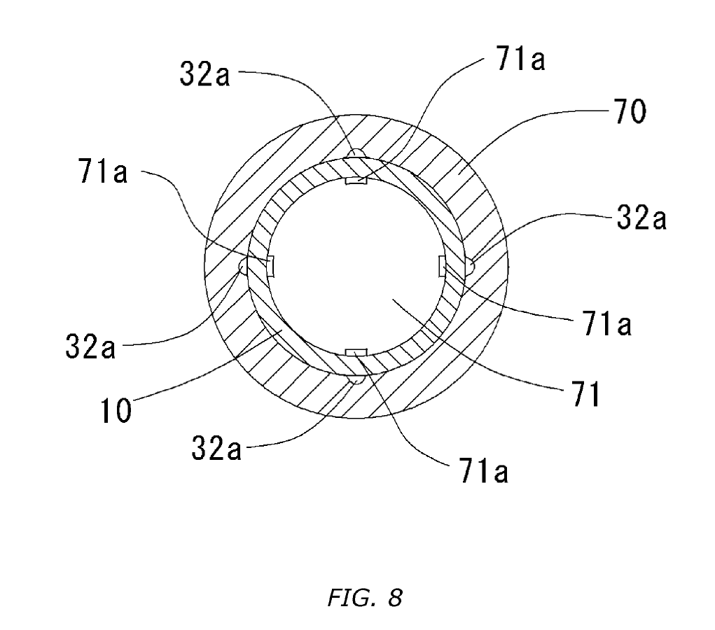

The details of the axial gap 50 of FIG. 2 will be described with reference to FIGS. 7 and 8. FIG. 7 is a cross section taken along line Y-Y of FIG. 2 of the housing and seen from the direction of the arrow. Reference numeral 70 is given to the housing in FIG. 2.

FIG. 8 is a cross section taken along line Y-Y of FIG. 2 in a state where the housing 70 and the sleeve 10 are combined.

Referring now to FIG. 7, recesses 71a extending outward in the radial direction from the center portion of a bottom part 71 of the housing 70 are formed in the bottom part 71 of the housing 70. The recesses 71a communicate with the communication holes 32. In a portion other than the portions in which the recesses 71a are formed, the lower face of the sleeve 10 and the upper face of the bottom part 71 come into contact with each other.

Referring to FIG. 8, the recesses 71a are formed so as to extend to the inside of the inner peripheral surface of the sleeve 10. As a result, the gap between the outer peripheral surface of the shaft 20 and the inner peripheral surface of the sleeve 10 and the communication hole 32 communicate with each other.

General Structure of Spindle Motor

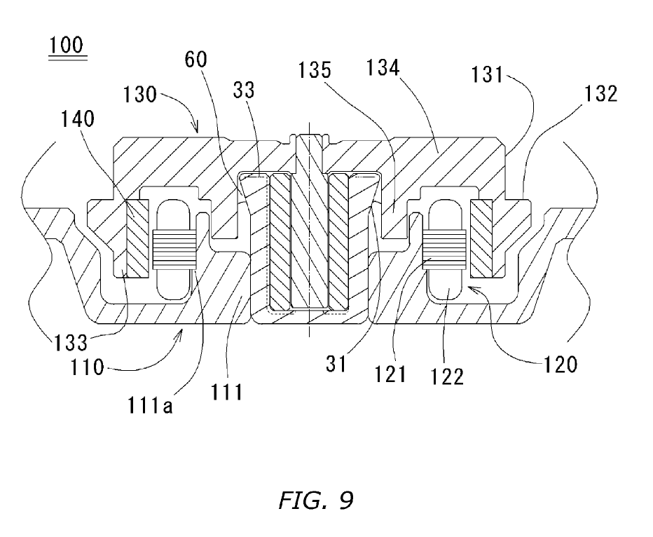

A motor 100 on which the fluid dynamic pressure bearing is mounted will be described with reference to FIG. 9. As the fluid dynamic pressure bearing device used in the motor 100, the fluid dynamic pressure device of FIG. 1 is used here. FIG. 9 is a schematic cross section taken along the axial direction.

In a base 110, a cylindrical part 111 to which the lower side of the outer peripheral surface of the housing 30 is fixed by, for example, adhesion is formed. A step 111a is formed in the outer peripheral surface of the cylindrical part 111. To the step 111a, an armature 120 formed in a circular shape is fixed by, for example, adhesion.

The armature 120 is formed by an armature core 121 formed by stacking a plurality of thin flat rolled magnetic steel sheets and strips and a conductor 122 wound around the armature core 121.

A rotating hub 130 is fixed to the upper part of the shaft 20 by, for example, adhesion. In the rotating hub 130, an upper cylindrical part 131 for fixing a recording disk which will be described later (not shown in FIG. 9) is formed. The rotating hub 130 is formed so that a disk mounting surface 132 on which a recording disk is to be mounted extends to the outside in the radial direction of the lower side of the upper cylindrical part 131. Below the disk mounting surface 132, a lower cylindrical part 133 is formed. A lid part 134 of the rotating hub 130 is formed so as to couple the shaft 20 and the upper cylindrical part 131. In a lower face of the lid part 134, an inner cylindrical part 135 is formed on the inside in the radial direction of the upper cylindrical part 131.

The inner peripheral surfaces of the upper cylindrical part 131, the disk mounting surface 132, and the lower cylindrical part 133 of the rotating hub 130 having the uniform diameter are coupled to each other. A rotor magnet 140 is fixed to the inner peripheral surfaces by, for example, adhesion. The inner peripheral surface of the rotor magnet 140 and the outer peripheral surface of the armature 120 are disposed with a gap in the radial direction.

In an upper face of the housing 30, a plurality of thrust generating grooves 33 are formed so as to generate a thrust dynamic pressure between the top face of the housing 30 and the lower face of the lid part 134 of the rotating hub 130. The gap between the inner peripheral surface of the inner cylindrical part 135 and the outer peripheral surface of the taper part 31 of the housing 30 is filled with the lubricating fluid 60 which forms the interface.

By passing current to the armature 120, a magnetic field is generated. By the interaction between the magnetic field and the rotor magnetic 140, the motor is rotated.

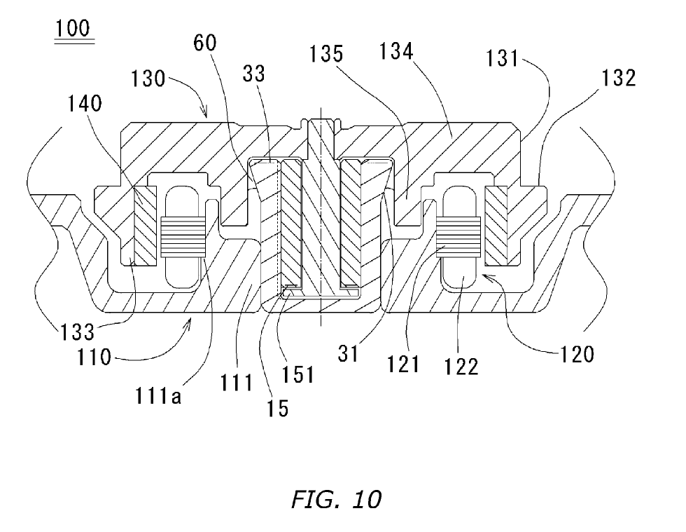

Another embodiment of the motor according to the invention will be described by referring to FIG. 10. FIG. 10 is a schematic cross section taken along the axial direction. The same members as those in FIG. 9 are indicated by the same numbers and the parts different from those in FIG. 9 will be described.

Referring to FIG. 10, a radial swollen part 151 extending outward in the radial direction is formed in a lower part of a shaft 150. The radial swollen part 151 is housed in the axial gap 50. A plurality of thrust dynamic pressure generating grooves 15 for generating thrust dynamic pressure between the lower face of the sleeve 10 and the upper face of the radial swollen part 151 are formed in the under face of the sleeve 10. Alternately, the thrust dynamic pressure generating grooves 15 may be formed in the top face side of the radial swollen part 151. The radial swollen part 151 may be formed by a separate member.

Recording Disk Driving Apparatus

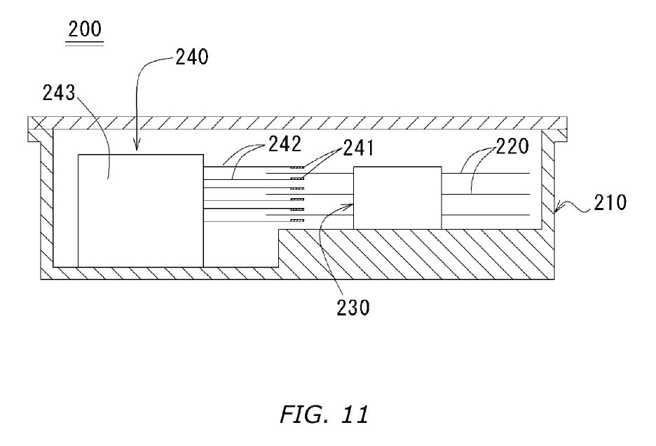

An embodiment of a recording disk driving apparatus 200 of the present invention will now be described with reference to FIG. 11.

The recording disk driving apparatus 200 has a rectangular-shaped housing 210. In the housing 210, a clean space including an extremely small amount of dusts and the like is formed. In the space, a spindle motor 230 on which a disc-shaped recording disk 220 for recording information is mounted is disposed.

In the housing 210, a head moving mechanism 240 for reading/writing information from/to the recording disk 220 is disposed. The head moving mechanism 240 is constructed by a magnetic head 241 for reading/writing information from/to the recording disk 220, an arm 242 supporting the magnetic head 241, and an actuator 243 for moving the magnetic head 241 and the arm 242 to a predetermined position above the recording disk 220.

By mounting a motor as shown in FIG. 9 or 10 on the recording disk driving apparatus 200 as described above, reduction in vibration can be realized while assuring sufficient functions. Thus, the recording disk driving apparatus 200 having high reliability and high durability can be provided.

Although the embodiment of the invention has been described above, the invention is not limited to the foregoing embodiment but can be variously modified.

In the embodiment of the invention, the tapered part 31 is provided in the upper part of the housing 30. The invention, however, is not limited to the structure. Any structure in which the lubricating fluid 60 circulates between the communication hole 32 formed in the housing 30 and the bearing part (the dynamic pressure generating groove 11) supporting the shaft 20 may be employed. Therefore, the housing 30 may have a shape covering the top face of the sleeve 10. In this case, a gap communicating the bearing part and the communication hole 32 is formed between the part covering the top face of the sleeve 10 of the housing 30 and the top face of the sleeve 10.

Although the communication hole 32 is formed almost parallel to the axial direction in the embodiment of the invention, the invention is not limited to the configuration. It is sufficient that the communication hole 32 be formed along the axial direction. For example, the communication hole 32 may be formed spirally.

What is claimed is:

1. A dynamic pressure bearing device comprising:
a shaft rotating about a rotation axis;
a cylindrical-shaped sleeve formed by a sintered metal having an inner peripheral surface along which the shaft is inserted;
a bearing part supporting the shaft rotating relative to the sleeve by a lubricating fluid filled in a dynamic pressure generating groove formed in at least one of an outer peripheral surface of the shaft and the inner peripheral surface of the sleeve and a gap in which the dynamic pressure generating groove is formed;
a housing having an inner peripheral surface which comes into contact with the outer peripheral surface of the sleeve; and
a counter plate hermetically closing a lower side of the housing and forming an axial gap with a lower face of the sleeve; wherein
one or more communication holes communicating at least from an upper face of the sleeve to a lower face thereof along an axial direction are formed in the inner peripheral surface of the housing, and
the communication hole(s) is filled with the lubricating fluid.

2. A dynamic pressure bearing device according to claim 1, wherein:
the lower face of the sleeve and the upper face of the counter plate are in contact with each other; and
the axial gap is formed by a recess extending outward in a radial direction at least from an inside of the inner peripheral surface of the sleeve and communicating with the communication hole(s) in the upper face of the counter plate.

3. A spindle motor having a dynamic pressure bearing device according to claim 1, the spindle motor comprising:
a base having a cylindrical part which is fit to the outer peripheral surface of the housing; and
a rotor hub formed so as to surround the housing and having a stator formed in an annulus shape and fixed to the outer peripheral surface of the cylindrical part, and a rotor magnet fixed to an upper part of the shaft and disposed with a space in the radial direction from the stator.

4. A spindle motor having a dynamic pressure bearing device according to claim 2, the spindle motor comprising:
a base having a cylindrical part which is fit to the outer peripheral surface of the housing; and
a rotor hub formed so as to surround the housing and having a stator formed in an annulus shape and fixed to the outer peripheral surface of the cylindrical part, and a rotor magnet fixed to an upper part of the shaft and disposed with a space in the radial direction from the stator.

5. A dynamic pressure bearing device according to claim 1, wherein:
the housing is formed by plastic process or resin molding; and
the communication hole(s) is formed simultaneously and integrally with the housing formed by plastic process or resin molding.

6. A spindle motor according to claim 3, wherein:
the housing is formed by plastic process or resin molding; and
the communication hole(s) and the thrust dynamic pressure generating groove are formed simultaneously and integrally with the housing formed by plastic process or resin molding.

7. A dynamic pressure bearing device comprising:
a shaft rotating along a rotation axis;
a cylindrical-shaped sleeve formed by a sintered metal having an inner peripheral surface along which the shaft is inserted;
a bearing part supporting the shaft rotating relative to the inner peripheral surface of the sleeve by a lubricating fluid filled in a dynamic pressure generating groove formed in at least one of an outer peripheral surface of the shaft and the inner peripheral surface of the sleeve and a gap in which the dynamic pressure generating groove is formed;
a housing having an inner peripheral surface which comes into contact with a outer peripheral surface of the sleeve, and a bottom part formed so as to be continued from the inner peripheral surface; and
an axial gap formed between a lower face of the sleeve and a upper face of the bottom; wherein
one or more communication holes communicating at least from a upper face of he sleeve to the lower face thereof along an axial direction are formed in the inner eripheral surface of the housing, and
the communication hole(s) is filled with the lubricating fluid.

8. A dynamic pressure bearing device according to claim 7, wherein:
the lower face of the sleeve and the upper face of the lower of the housing are in contact with each other; and
the axial gap is formed by a recess extending outward in the radial direction at least from the inside of the inner peripheral surface of the sleeve and communicating with the communication hole(s) in an upper face of the bottom part of the housing.

9. A spindle motor having a dynamic pressure bearing device according to claim 7, the spindle motor comprising:
a base having a cylindrical part which is fit to the outer peripheral surface of the housing; and
a rotor hub formed so as to surround the housing and having a stator formed in an annulus shape and fixed to the outer peripheral surface of the cylindrical part, and a rotor magnet fixed to an upper part of the shaft and disposed with a space in the radial direction from the stator.

10. A spindle motor having a dynamic pressure bearing device according to claim 8, the spindle motor comprising:
a base having a cylindrical part which is fit to the outer peripheral surface of the housing; and
a rotor hub formed so as to surround the housing and having a stator formed in an annulus shape and fixed to the outer peripheral surface of the cylindrical part, and a rotor magnet fixed to an upper part of the shaft and disposed with a space in the radial direction from the stator.

11. A dynamic pressure bearing device according to claim 7, wherein:
the housing is formed by plastic process or resin molding; and
the communication hole(s) is formed simultaneously and integrally the housing is formed by plastic process or resin molding.

12. A dynamic pressure bearing device according to claim 8, wherein:
the housing is formed by plastic process or resin molding; and
the communication hole(s) and the axial gap are formed simultaneously and integrally the housing is formed by plastic process or resin molding.

13. A spindle motor according to claim 9, wherein:
the housing is molded by plastic process or resin molding; and
the communication hole(s) and the thrust dynamic pressure generating groove are formed simultaneously and integrally the housing is formed by plastic process or resin molding.

14. A spindle motor according to claim 10, wherein:
the housing is formed by plastic process or resin molding; and
the communication hole(s), the axial gap, and the thrust dynamic pressure generating groove are formed simultaneously and integrally the housing is formed by plastic process or resin molding.

15. A recording disk driving apparatus on which the spindle motor according to claim 4 is mounted, the recording disk driving apparatus comprising:
a recording disk rotating along a rotation axis while being fixed to the rotating hub;
a magnetic head for magnetically writing/reading information to/from the recording disk;
an arm supporting the magnetic head;
an actuator enabling the magnetic head and the arm to move in the circumferential direction; and
a casing housing the above components.

16. A recording disk driving apparatus on which the spindle motor according to claim 7 is mounted, the recording disk driving apparatus comprising:
a recording disk rotating along a rotation axis while being fixed to the rotating hub;
a magnetic head for magnetically writing/reading information to/from the recording disk;
an arm supporting the magnetic head;
an actuator enabling the magnetic head and the arm to move in the circumferential direction; and
a casing housing the above components.
